(19) United States
(12) Patent Application Publication
(10) Pub. No.: US 2022/0000714 A1
(43) Pub. Date: Jan. 6, 2022

(54) METHOD FOR IMPROVING BLOOD FLOW OF THE CEREBRAL CORTEX

(71) Applicant: Yan-Chih LIAO, Taipei City (TW)

(72) Inventors: Ching-Heng LIN, New Taipei City (TW); Chuang-Hsin CHIU, Taipei City (TW); Mei-Chun WANG, Taipei City (TW); Chi-Tun TANG, Taipei City (TW); Chen-Yu LEE, Taipei City (TW); Yan-Chih LIAO, Taipei City (TW)

(21) Appl. No.: 16/919,133

(22) Filed: Jul. 2, 2020

(51) Int. Cl. A61H 39/08; A61H 39/00

(52) U.S. Cl. CPC A61H 39/086; A61H 2209/00; A61H 2205/02; A61H 39/002

(57) ABSTRACT

A method for improving blood flow of the cerebral cortex is provided in the present invention. The method for improving blood flow of the cerebral cortex includes the following steps: stimulating a predetermined site of a subject in need thereof to improve blood flow of the cerebral cortex of the subject in need thereof, wherein the predetermined site is Shousanli (LI10) acupoint.

### BACKGROUND OF THE INVENTION

### 1. Field of the Invention

The present invention relates to a method for improving blood flow of the cerebral cortex, and more specifically, a method for treating Parkinson's disease.

### 2. Description of Related Art

Due to the potential of acupuncture for treating diseases, traditional acupuncture has drawn increasing attention in recent years, with the World Health Organization (WHO) integrating traditional Chinese medicine into the International Statistical Classification of Diseases and Related Health Problems (ICD) in 2019. Acupuncture plays a pioneering role in the advancement and development of traditional Chinese medicine, and the principles of applying acupuncture are based on the practices of traditional Chinese medicine theory. Additionally, the efficacy of acupuncture for treating disease is now widely recognized by Western countries.

Acupuncture is integrally related to the mechanisms of the human body and the central nervous system. The stimulation of acupuncture affects the brain, promoting the regulation of the brain and thereby the functioning of body systems in the process of maintaining homeostasis.

Parkinson's disease is a chronic degenerative disease of the brain, which mainly affects the function of the motor nervous system, and is common in people 50 to 60 years old. Parkinson's disease is caused by the degradation or death of substantia nigra cells in the brain, which effectively reduces the secretion of the neurotransmitter “dopamine” in the brain. When the brain lacks dopamine, the motor circuits in the brain will be significantly inhibited, leading to the symptoms of shaking, rigidity, slowness of movement, and loss of balance. Although Parkinson's disease does not cause dementia symptoms, it heavily breaks down normal motor functions. Unfortunately, there is currently no effective cure for Parkinson's disease, and the symptoms are merely alleviated by taking levodopa (L-DOPA), dopamine agonists, or monoamine oxidase inhibitors.

Although medical professionals still do not fully understand the reasons behind the decrease in substantia nigra cells, it is reported that it may be caused by disorders of the sympathetic nervous system and autonomic nervous system. Pressures faced in daily life may lead to vasoconstriction, resulting in brain ischemia, which causes the substantia nigra tissue to degenerate, atrophy, and even die. Since the substantia nigra tissue requires an abundance of blood, compromised by ischemia, the brain thus cannot obtain sufficient circulating nutrients and oxygen. In the end, it results in the symptoms of Parkinson's disease.

Therefore, there is an urgent need to provide treatment for patients with Parkinson's disease in order to prevent or relieve the symptoms.

### SUMMARY OF THE INVENTION

The present invention relates to a method for improving blood flow of the cerebral cortex by stimulating a specific acupoint in order to redistribute the blood flow to the cortical area, subcortical area, brainstem area, or even the striatum. In this way, the symptoms of Parkinson's disease can be effectively prevented or relieved.

The present invention relates to a method for improving blood flow of the cerebral cortex and comprises the following steps: stimulating a predetermined site of a subject in need thereof to improve the blood flow of the cerebral cortex of the subject in need thereof, wherein the predetermined site is Shousanli (1110) acupoint.

In the present invention, the predetermined site of the subject in need thereof is stimulated with an acupuncture needle, electricity, or a combination thereof. In one aspect of the present invention, the predetermined site of the subject in need thereof is stimulated with an acupuncture needle.

In the method for improving blood flow of the cerebral cortex according to the present invention, the step of stimulating the predetermined site of the subject in need thereof may comprise the following steps: inserting and retaining an acupuncture needle to the predetermined site of the subject in need thereof and then rotating the acupuncture needle. The acupuncture needle may be rotated in an alternating clockwise and counterclockwise manner. Preferably, the acupuncture needle is alternately rotated clockwise 90 to 270 degrees and counterclockwise 90 to 270 degrees. More preferably, the acupuncture needle is alternately rotated clockwise 120 to 180 degrees and counterclockwise 120 to 180 degrees, But, the present invention is not limited thereto. In addition, the length of the acupuncture needle may be between 7.5 to 75 mm, preferably between 7.5 to 50 mm, and more preferably between 7.5 to 25 mm, but the present invention is not limited thereto. Further, the diameter of the acupuncture needle may be between 0.2 to 0.35 mm, preferably between 0.2 to 0.3 mm, and more preferably between 0.2 to 0.25 mm, but the present invention is not limited thereto.

The method for improving blood flow of the cerebral cortex according to the present invention may further comprise a step: retaining the acupuncture needle after insertion and letting it stand still for a period of time prior to rotating the acupuncture needle. The first period of time may be between 3 to 5 minutes, preferably 4 minutes, but the present invention is not limited thereto.

The method for improving blood flow of the cerebral cortex according to the present invention may further comprise a step: repeating the step of retaining the acupuncture needle after insertion and letting the acupuncture needle stand still and the step of rotating the acupuncture needle for a predetermined number of times. The predetermined number of times may be 1 to 10 times, preferably 1 to 7 times, more preferably 3 to 5 times, and most preferably 4 times, but the present invention is not limited thereto.

In the method for improving blood flow of the cerebral cortex according to the present invention, the acupuncture needle may be continuously rotated for a second period of time. The second period of time may be between 30 to 120 seconds, preferably between 30 to 90 seconds, more preferably between 0.45 to 75 seconds, and most preferably about 60 seconds, but the present invention is not limited thereto.

In the method for improving blood flow of the cerebral cortex according to the present invention, the cerebral cortex comprises the hippocampus, striatum, thalamus, precuneus, cingulum, or cerebellum, but the present invention is not limited thereto.

In the method for improving blood flow of the cerebral cortex according to the present invention, the method may be used to treat Parkinson's disease.

Other objects, advantages, and novel features of the invention will become more apparent from the following detailed description when taken in conjunction with the accompanying drawings.

### BRIEF DESCRIPTION OF THE DRAWINGS

FIG. 1 (A) to FIG. 1 (J) shows the value differences of the uptake ratio (UR) in brain regions for “baseline” and “after acupuncture”, compared by using paired t-test.

FIG. 2 shows the changes of uptake ratios of “baseline” and “after acupuncture”.

FIG. 3 shows the hippocampus images of “baseline” and “after acupuncture”, as denoted by the arrows.

FIG. 4 shows the striatum and thalamus images of “baseline” and “after acupuncture”, as denoted by the arrows,

FIG. 5 shows the precuneus images of “baseline” and “after acupuncture”, as denoted by the arrows.

FIG. 6 shows the cingulum images of “baseline” and “after acupuncture”, as denoted by the arrows.

FIG. 7 shows the cerebellum images of “baseline” and “after acupuncture”, as denoted the arrows.

### DETAILED DESCRIPTION OF TI-IE PREFERRED EMBODIMENT

Different embodiments of the present invention are provided in the following description. These embodiments are meant to explain the technical content of the present invention, but not meant to limit the scope of the present invention. A feature described in an embodiment may be applied to other embodiments by suitable modification, substitution, combination, or separation.

The present invention relates to a method for improving blood flow of the cerebral cortex, comprising the following steps: stimulating a predetermined site of a subject in need thereof with an acupuncture needle, electricity, or a combination thereof to improve blood flow of the cerebral cortex, wherein the predetermined site is Shousanli (LI10) acupoint. In addition, in one aspect of the present invention, the predetermined site of a subject in need thereof is stimulated with an acupuncture needle, but the present invention is not limited thereto.

In the present invention, the step of stimulating the predetermined site of the subject in need thereof further comprises the following steps: inserting and retaining an acupuncture needle at the predetermined site of the subject in need thereof and then rotating the acupuncture needle, wherein the acupuncture needle can be rotated in an alternating clockwise and counterclockwise manner. In addition, the method of the present invention further comprises a step: letting the acupuncture needle first stand still for a period of time prior to rotating the acupuncture needle. Moreover, the method of the present invention further comprises a step: repeating the step of letting the acupuncture needle stand still after insertion and the step of rotating the acupuncture needle for a predetermined number of times. Furthermore, in the method of the present invention, the acupuncture needle can be continuously rotated for a second period of time.

In the end, the method of the present invention can be used to redistribute blood flow of the cerebral cortex, wherein the cerebral cortex comprises the hippocampus, striatum, thalamus, precuneus, cingulum, or cerebellum. Thereby, the method of the present invention can be used to treat Parkinson's disease, but the present invention is not limited thereto.

Experimental Method

In the method for improving blood flow of the cerebral cortex according to the present invention, Technetium-99m ethyl cysteinate dimer (^{99m} Tc-ECD) was administered via intravenous injection and used as a radioactive tracer, and single photon emission computed tomography (SPECT) was used to detect the brain of a healthy adult subject and obtain information of cerebral blood flow perfusion. Then, the numerical changes of blood flow in each brain region were obtained by quantitative analysis software, thereby elucidating the condition of blood flow perfusion before/after stimulating Shousanli (LI10) acupoint. After the scanned image was reconstructed by the original manufacturer, the spatial normalization of the brain image was performed with Pmod software (Pmod Technologies, Switzerland), and then the automated anatomical labeling (AAL) was performed to identify the volume of interest (VOI) in the brain.

The steps of the method for improving blood flow of the cerebral cortex according to the present invention can be divided into a first part and a second part, wherein the first part is to obtain baseline values of a subject and the second part is the detection after acupuncture.

For the first part, an intravenous needle is placed on the subject's hand and then the subject is instructed to take a rest in a dark room for 30 minutes. After resting for 30 minutes, the subject is injected with ^{99m}Tc-ECD tracer, instructed to rest for another 30 minutes in a dark room, and then the SPECT′ scan is performed. For the second part, an intravenous needle is placed on the subject's hand, the subject takes a rest in a dark room for 30 minutes, and then an acupuncture needle is inserted to stimulate the Shousanli (WO) acupoint of the left hand (located on the dorsal radial side of the forearm and 2 cun below the transverse cubital crease). While retaining the acupuncture needle at Shousanli (LI10) acupoint, a needle-twirling technique is performed at intervals of several minutes, with breaks of several minutes in between the application of the needle-twirling technique. This process of applying the needle-twirling technique with breaks in between intervals is repeated for a determined number of times. The needle-twirling technique entails gripping the needle handle with the thumb and index finger at the same time, continuously rotating the needle clockwise and counterclockwise, and repeating this needle manipulation several times per minute. The needle is removed after the aforementioned manipulation has been completed, a sterile cotton ball is pressed on the needle insertion site for 30 seconds, and then ^{99m}Tc-ECD tracer is injected. After receiving the injection, the subject takes a rest in a dark room for 30 minutes, and then SPECT scan is performed. Statistical analysis software is used to perform normalization on the images obtained by the present Experimental Method, thereby obtaining the redistribution information of blood flow perfusion in different regions of the brain before and after stimulating the acupoint.

### Embodiment 1

In the present embodiment, an acupuncture needle with a length of 7.5 mm and a diameter of 0.3 mm was inserted at the Shousanli (WO) acupoint on the left hand. The first period of time was 4 minutes, the second period of time was 1 minute, the predetermined number of times was 4 times, and the needle was retained for 20 minutes in total. The needle-twirling technique entailed gripping the needle handle with the thumb and index finger at the same time, continuously rotating the needle clockwise 180 degrees and counterclockwise 180 degrees, repeating this manipulation 140 times per minute.

### Embodiment 2

The present embodiment was similar to Embodiment 1 except that the first period of time was 3 minutes, the second period of time was 1 minute, and the predetermined number of times was 5 times. Just as in Embodiment 1, the needle was retained for 20 minutes in total.

### Embodiment 3

The present embodiment was similar to Embodiment 1 except that the first period of time was 5 minutes, the second period of time was 1 minute, the predetermined number of times was 5 times, and the needle was retained for 30 minutes in total.

### Embodiment 4

The present embodiment was similar to Embodiment 1 except that the first period of time was 4 minutes, the second period of time was 2 minutes, the predetermined number of times was 5 times, and the needle was retained for 30 minutes in total.

### Embodiment 5

The present embodiment was similar to Embodiment 1 except that the first period of time was 3 minutes and the second period of time was 2 minutes. Just as in Embodiment 1, the predetermined number of times was 4 times and the needle was retained for 20 minutes in total.

### Embodiment 6

The present embodiment was similar to Embodiment 1 except that the first period of time was 5 minutes, the second period of time was 2 minutes, the predetermined number of times was 5 times, and the needle was retained for 35 minutes in total.

### Embodiment 7

The present embodiment was similar to Embodiment 1 except that the needle-twirling technique entailed gripping the needle handle with the thumb and index finger at the same time, continuously rotating the needle clockwise 90 degrees and counterclockwise 90 degrees, repeating this manipulation 250 times per minute.

### Embodiment 8

The present embodiment was similar to Embodiment 2 except that the needle-twirling technique entailed gripping the needle handle with the thumb and index finger at the same time, continuously rotating the needle clockwise 90 degrees and counterclockwise 90 degrees, repeating this manipulation 250 times per minute.

### Embodiment 9

The present embodiment was similar to Embodiment 3 except that the needle-twirling technique entailed gripping the needle handle with the thumb and index finger at the same time, continuously rotating the needle clockwise 90 degrees and counterclockwise 90 degrees, repeating this manipulation 250 times per minute.

### Embodiment 10

The present embodiment was similar to Embodiment 1 except that the needle-twirling technique entailed gripping the needle handle with the thumb and index finger at the same time, continuously rotating the needle clockwise 270 degrees and counterclockwise 270 degrees, repeating this manipulation 1.00 times per minute.

### Embodiment 11

The present embodiment was similar to Embodiment 2 except that the needle-twirling technique entailed gripping the needle handle with the thumb and index finger at the same time, continuously rotating the needle clockwise 270 degrees and counterclockwise 270 degrees, repeating this manipulation 100 times per minute.

### Embodiment 12

The present embodiment was similar to Embodiment 3 except that the needle twirling technique entailed gripping the needle handle with the thumb and index finger at the same time, continuously rotating the needle clockwise 270 degrees and counterclockwise 270 degrees, repeating this manipulation 100 times per minute.

Experimental Results

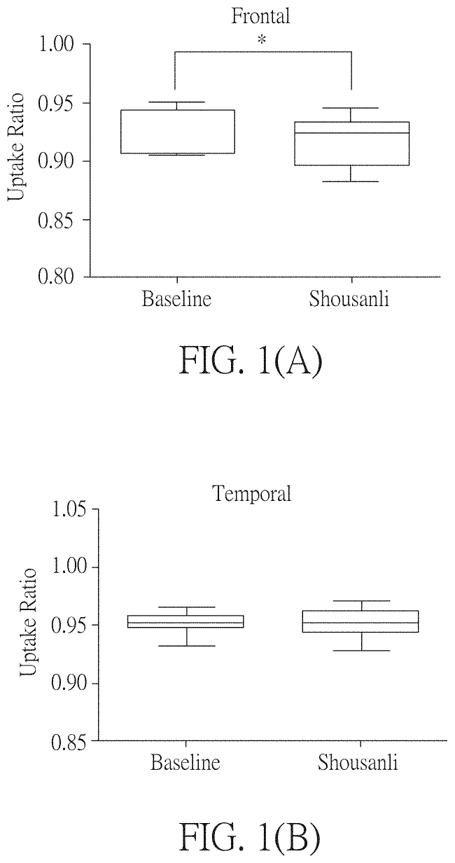

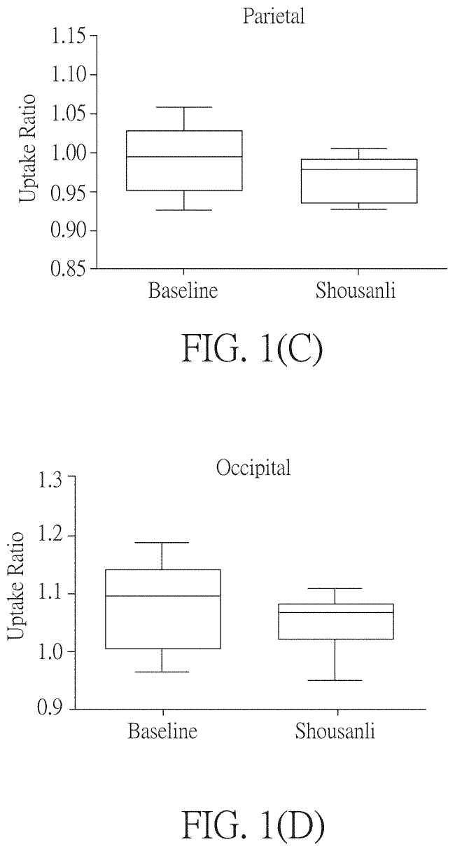

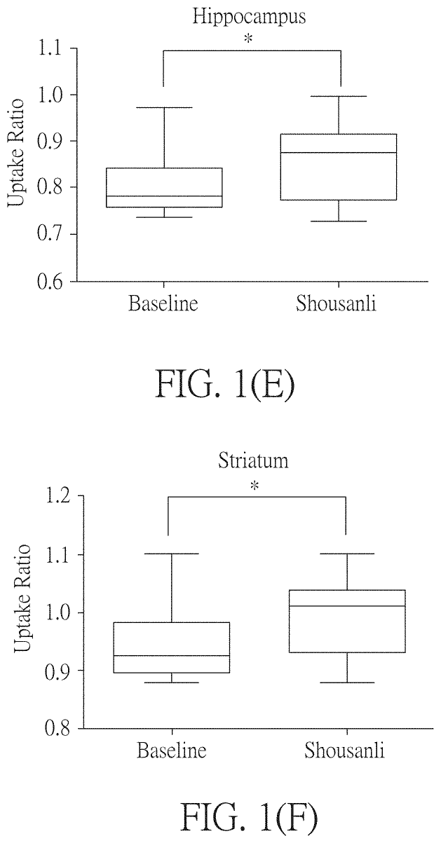

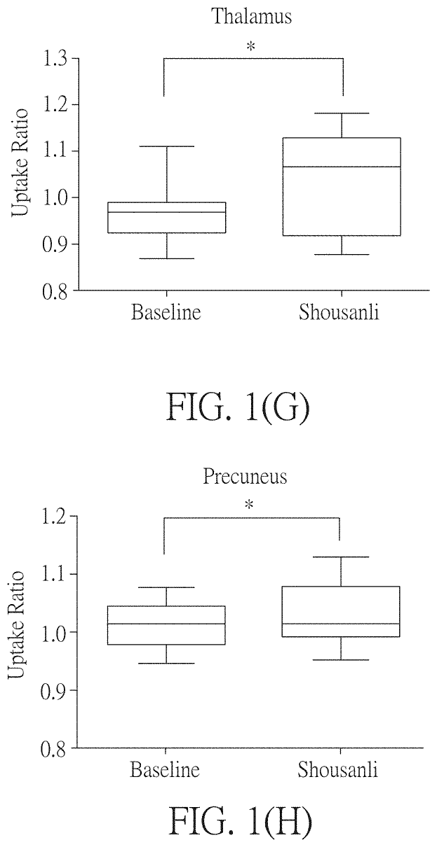

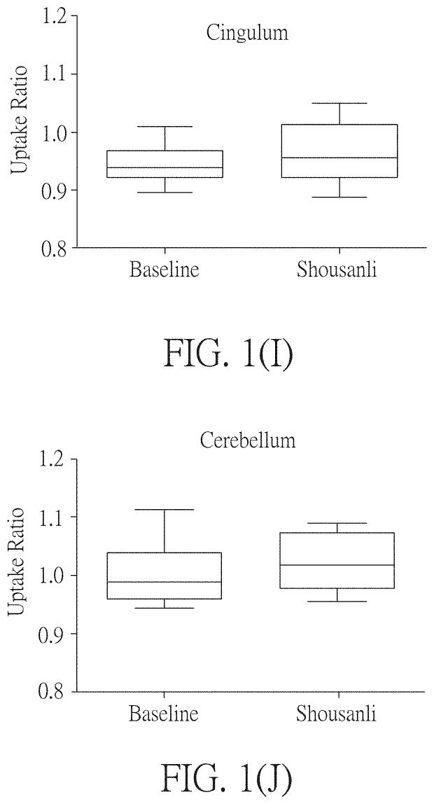

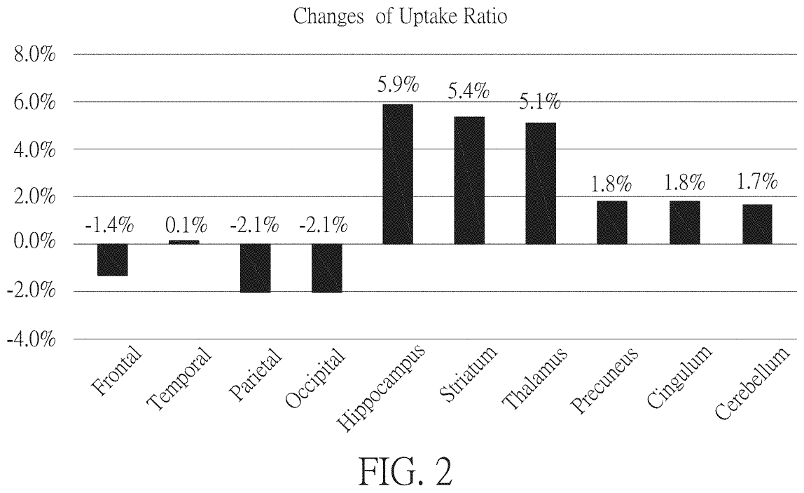

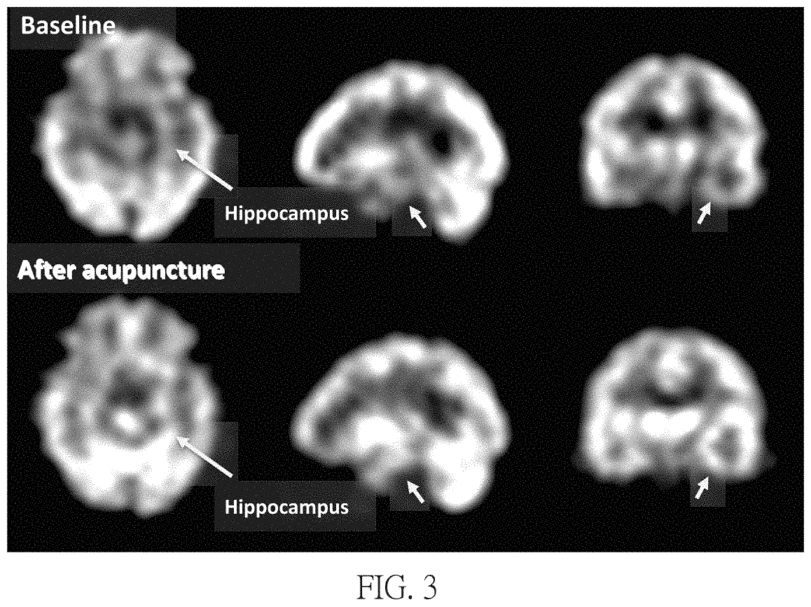

Table 1 shows the results obtained by performing the aforementioned Experimental Method under the operating conditions of Embodiment 1. As shown in Table 1 below, statistical analysis was performed to compare the differences of all subjects in various brain regions as shown in FIG. 1 (A) to FIG. 1 (J) and FIG. 2.

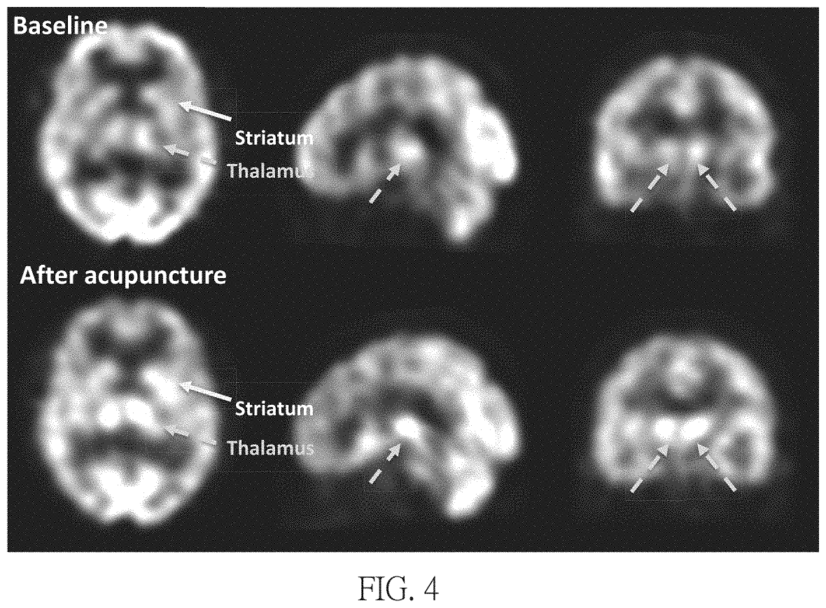

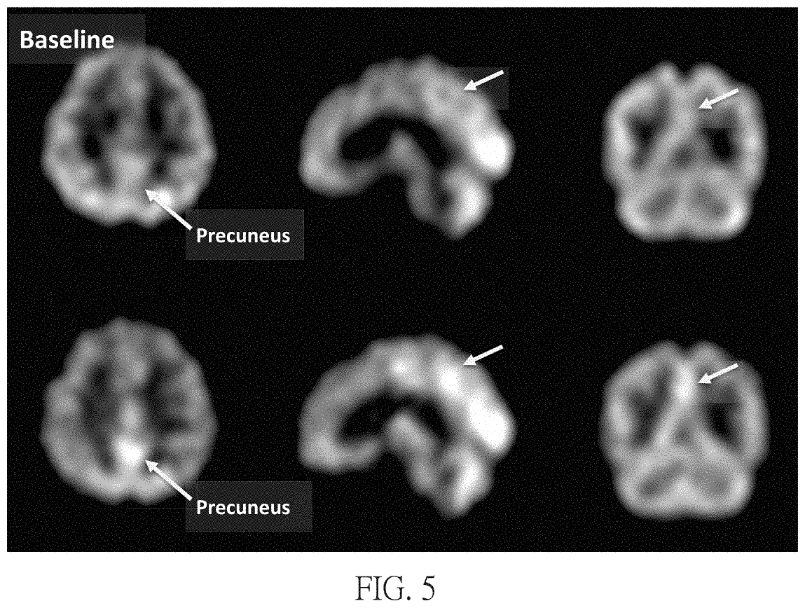

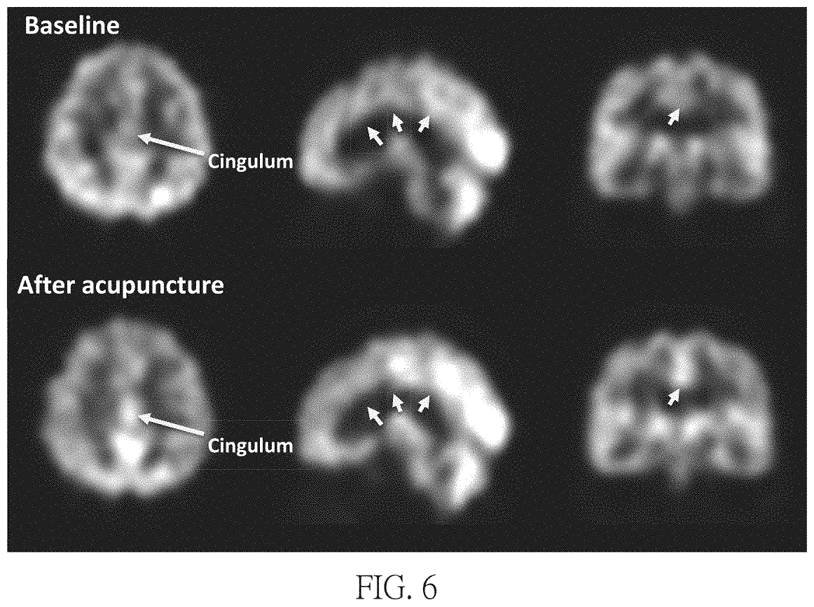

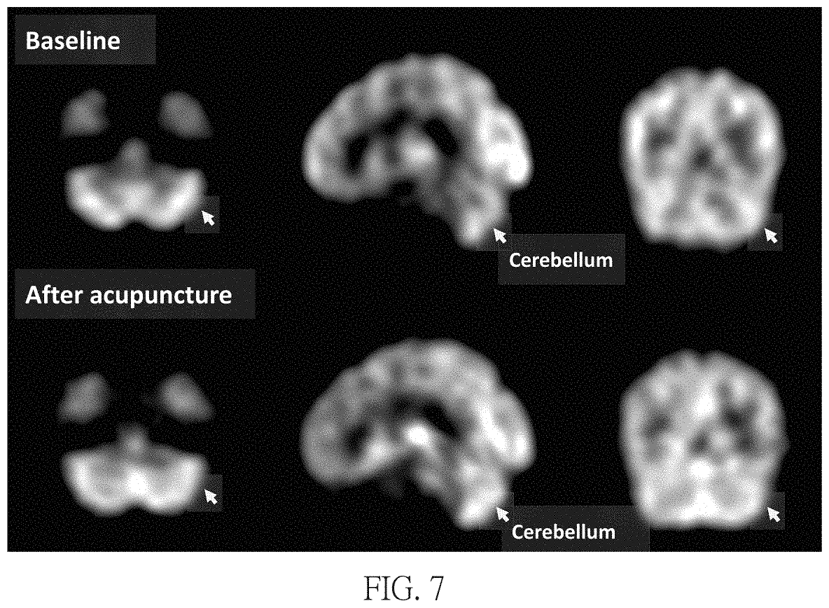

It can be found from the comparison between the data collected before and after stimulating Shousanli (LI10) acupoint that the cerebral blood flow perfusion increased dramatically in the various brain regions, including the hippocampus (FIG. 3), striatum (FIG. 4), thalamus (FIG. 4), precuneus (FIG. 5), cingulum (FIG. 6), or cerebellum (FIG. 7) in which FIGS. 3 to 7 were collected from the same subject. These results indicate that the method of the present invention can achieve the purpose of preventing, relieving and/or treating Parkinson's disease.

TABLE 1

| | Differences in cerebral blood flow |
|---|---|
| | perfusion after the stimulation of |
| Brain region | Shousanli (LI10) acupoint |
| frontal | −1.4% |
| temporal | 0.1% |
| parietal | −2.1% |
| occipital | −2.1% |
| hippocampus | 5.9% |
| striatum | 5.4% |
| thalamus | 5.1% |
| precuneus | 1.8% |
| cingulum | 1.8% |
| cerebellum | 1.7% |

Although the present invention has been explained in relation to its preferred embodiment, it is to be understood that many other possible modifications and variations can be made without departing from the spirit and scope of the invention as hereinafter claimed.

What is claimed is:

1. A method for improving blood flow of the cerebral cortex, comprising the following steps:
stimulating a predetermined site of a subject in need thereof to improve blood flow of the cerebral cortex, wherein the predetermined site is Shousanli (LI10) acupoint.

2. The method of claim 1, wherein the predetermined site of the subject in need thereof is stimulated with an acupuncture needle, electricity or a combination thereof.

3. The method of claim 1, wherein the step of stimulating the predetermined site of the subject in need thereof comprises the following steps:
applying an acupuncture needle to the predetermined site of the subject in need thereof, and
rotating the acupuncture needle.

4. The method of claim 3, further comprising a step:
retaining the acupuncture needle after insertion and letting it stand still for the first period of time prior to rotating the acupuncture needle.

5. The method of claim 4, wherein the first period of time is between 3 to 5 minutes.

6. The method of claim 3, wherein the acupuncture needle is continuously rotated for a second period of time.

7. The method of claim 6, wherein the second period of time is between 30 to 120 seconds.

8. The method of claim 3, wherein the acupuncture needle is rotated in an alternating clockwise and counterclockwise manner.

9. The method of claim 4, further comprising a step:
repeating the step of retaining the acupuncture needle after insertion and letting the acupuncture needle stand still and the step of rotating the acupuncture needle for a predetermined number of times, with breaks in between intervals of the standing still step and the rotating step.

10. The method of claim 9, wherein the predetermined number of times is 1 to 10 times.

11. The method of claim 3, wherein a length of the acupuncture needle is between 7.5 to 75 mm.

12. The method of claim 3, wherein a diameter of the acupuncture needle is between 0.2 to 0.35 mm.

13. The method of claim 1, wherein the cerebral cortex comprises the hippocampus, striatum, thalamus, precuneus, cingulum, or cerebellum.

14. The method of claim 1, wherein the method is used to treat Parkinson's disease.
